(19) United States
(12) Patent Application Publication
(10) Pub. No.: US 2017/0043515 A1
(43) Pub. Date: Feb. 16, 2017

(54) Thermoplastic Shell Assembly Formed Integrally by Embedding and Injection and Method for Manufacturing the Shell Assembly

(71) Applicant: Chih-Chia Wei, Taichung City (TW)

(72) Inventor: Chih-Chia Wei, Taichung City (TW)

(21) Appl. No.: 14/825,220

(22) Filed: Aug. 13, 2015

(51) Int. Cl. B29C 45/14; B32B 15/08; B21D 26/021; B32B 3/26

(52) U.S. Cl. CPC B29C 45/14311; B32B 3/266; B32B 15/08; B21D 26/021; B29C 2045/14327; B29C 2045/14868; B29K 2101/12

(57) ABSTRACT

A method is used for manufacturing a shell assembly which includes a metallic shell and a plastic material embedded into the metallic shell. The metallic shell has an outer surface provided with at least one slot. The at least one slot of the metallic shell is provided with a plurality of through holes. The plastic material is injected into the metallic shell, flows through the through holes of the metallic shell, and flows into and out of the at least one slot of the metallic shell during an injection molding process. Thus, the plastic material is embedded in the metallic shell so that the metallic shell and the plastic material are formed integrally.

### BACKGROUND OF THE INVENTION

1. Field of the Invention

The present invention relates to a thermoplastic shell assembly formed integrally by embedding and injection and a method for manufacturing the shell assembly.

2. Description of the Related Art

A conventional metallic shell assembly is not formed integrally and is divided into multiple parts which are initially manufactured individually and are then combined together to construct the metallic shell assembly. In fabrication, a metallic shell blank is processed by a CNC working procedure to form at least one slot. Then, the metallic shell blank is processed by an anodizing treatment. Then, the metallic shell blank is combined with a plastic material by an injection process to form the metallic shell assembly. However, the conventional metallic shell assembly has a higher cost of fabrication. In addition, the working cutter is worn out during a long-term utilization, thereby decreasing the working precision, thereby decreasing the quality of the product, and thereby easily producing flawed products. Further, the chemical agents remaining after the anodizing treatment will erode the metal and the plastic material. Further, the plastic material is much higher than the slot of the metallic shell during the injection process, thereby easily causing an uncomfortable sensation to the user when touching the plastic material.

### BRIEF SUMMARY OF THE INVENTION

In accordance with the present invention, there is provided a shell assembly comprising a metallic shell and a plastic material embedded into the metallic shell. The metallic shell has an outer surface provided with at least one slot. The metallic shell has an inner surface provided with at least one protruding arcuate face aligning with the at least one slot. The metallic shell is processed by an anodizing treatment. The at least one arcuate face of the metallic shell is processed by a CNC working procedure to have an insulating function. The inner surface of the metallic shell is provided with at least one worked portion which is processed by an etching process or a laser engraving working procedure. The at least one worked portion of the metallic shell is coated with a glue. The at least one slot of the metallic shell is provided with a plurality of through holes. The plastic material is injected into the metallic shell, flows through the through holes of the metallic shell, and flows into and out of the at least one slot of the metallic shell during an injection molding process.

In accordance with the present invention, there is also provided a method for manufacturing a shell assembly, comprising a first step, a second step, a third step, a fourth step and a fifth step. The first step includes placing a metallic plate in a lower die which has a periphery provided with an annular groove for mounting a separation washer which has a top higher than a top plane of the lower die, placing the metallic plate on the top of the separation washer, moving an upper die downward to apply a determined pressure on the metallic plate, heating the lower die and the upper die by a heating device to reach a proper temperature so as to deform the metallic plate, delivering a high pressure gas through the upper die to blow and press the metallic plate into a lower die cavity of the lower die so as to form a metallic shell, moving the upper die upward to open the lower die, removing the metallic shell from the lower die cavity of the lower die, and trimming the metallic shell to remove a residual part so as to obtain an integrally formed product of the metallic shell. The second step includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, and coating a glue on the at least one worked portion of the metallic shell. The third step includes forming a plurality of through holes in the at least one slot of the metallic shell. The fourth step includes injecting the plastic material into the metallic shell to let the plastic material flow through the through holes of the metallic shell and flow into and out of the at least one slot of the metallic shell during an injection molding process. The fifth step includes finishing a shell assembly which is an integral combination of the metallic shell and the plastic material.

According to the primary advantage of the present invention, the plastic material is injected into and embedded in the metallic shell, so that the metallic shell and the plastic material are formed integrally.

According to another advantage of the present invention, the shell assembly is made easily and conveniently to reduce the cost of fabrication.

According to a further advantage of the present invention, the shell assembly has an enhanced working precision to increase the quality of the product and to decrease the possibility of producing flawed products.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view showing a metallic plate being placed on the top of a separation washer.

FIG. 2 is a schematic operational view of FIG. 1.

FIG. 3 is a schematic operational view of FIG. 2.

FIG. 4 is a schematic operational view of FIG. 3.

FIG. 5 is a cross-sectional view showing the plastic material flowing through the through holes of the metallic shell and flows into and out of the slots of the metallic shell.

FIG. 6 is a cross-sectional view showing the plastic material touching and pushing the arcuate mold.

FIG. 7 is a perspective view of a metallic shell of a shell assembly in accordance with the preferred embodiment of the present invention.

FIG. 8 is a perspective view of the shell assembly in accordance with the preferred embodiment of the present invention.

FIG. 9 is a longitudinal cross-sectional view of the shell assembly in accordance with the preferred embodiment of the present invention.

FIG. 10 is a transverse cross-sectional view of the shell assembly in accordance with the preferred embodiment of the present invention.

FIG. 11 is a flow chart of a method for manufacturing a shell assembly in accordance with the preferred embodiment of the present invention.

### DETAILED DESCRIPTION OF THE INVENTION

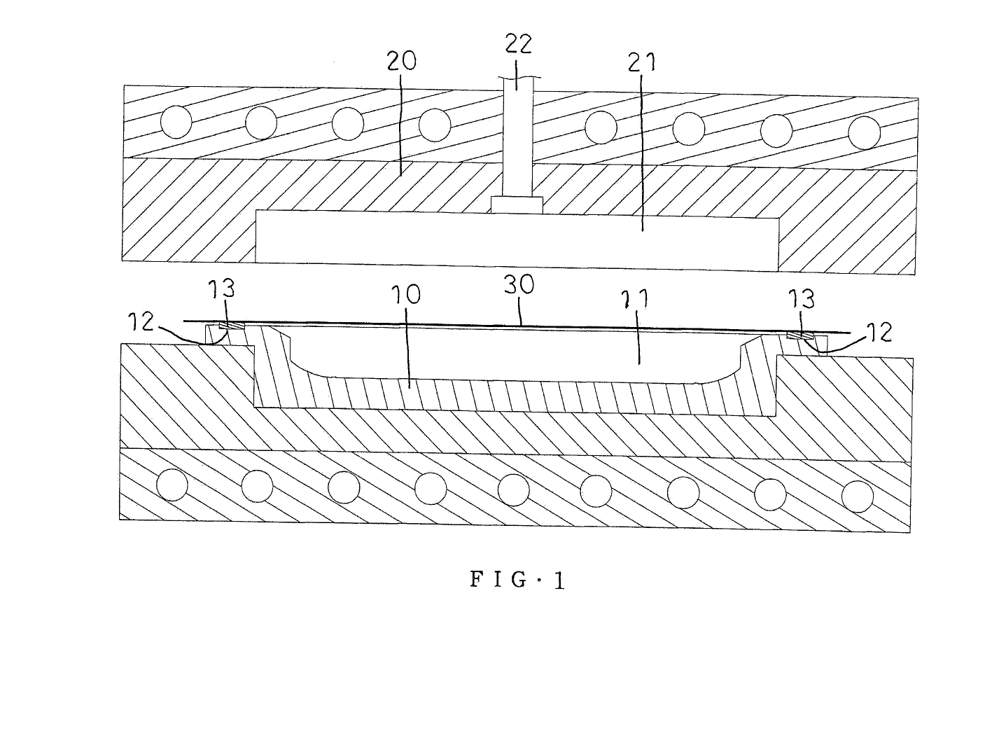

Referring to the drawings and initially to FIGS. 1-6, a method in accordance with the preferred embodiment of the present invention comprises providing a lower die 10, an upper die 20, a metallic plate 30 and a plastic material 40.

The lower die 10 has an interior provided with a lower die cavity 11 and has a periphery provided with an annular groove 12 for mounting a separation washer 13 which has a top higher than a top plane of the lower die 10.

The upper die 20 has an interior provided with an upper die cavity 21 aligning with the lower die cavity 11 of the lower die 10 and has a central portion provided with an input pipe 22 for delivering a high pressure gas.

The metallic plate 30 is slightly larger than the lower die cavity 11 of the lower die 10 and is placed on the top of the separation washer 13 of the lower die 10 as shown in FIG. 1.

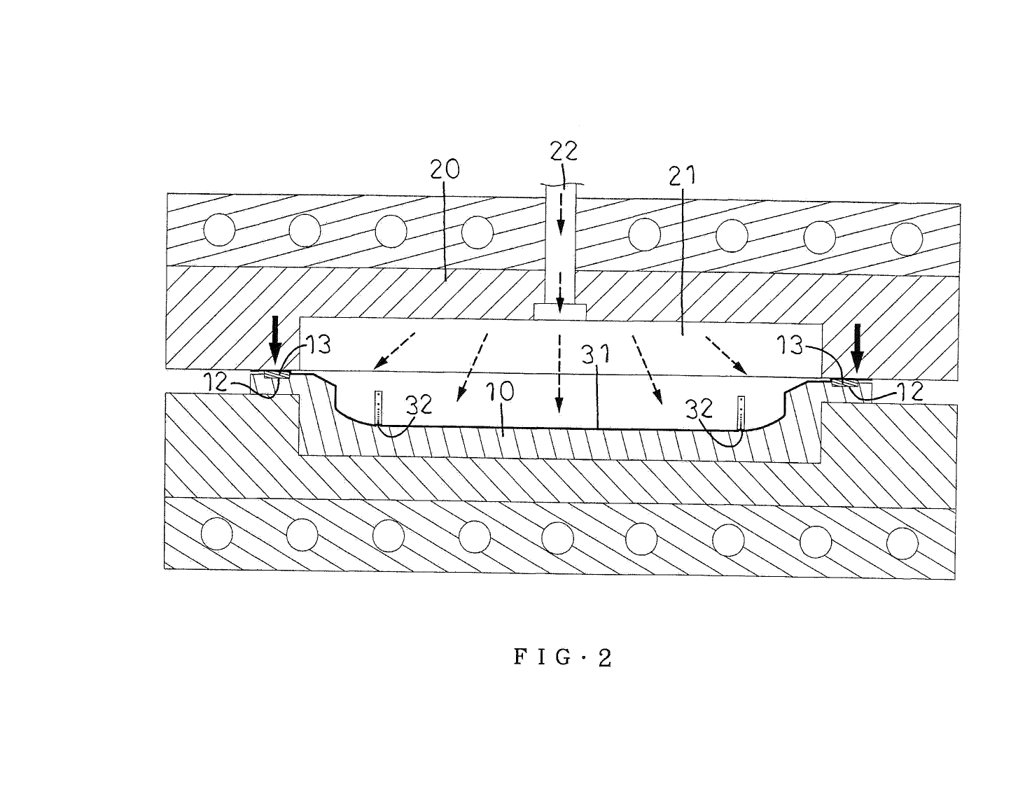

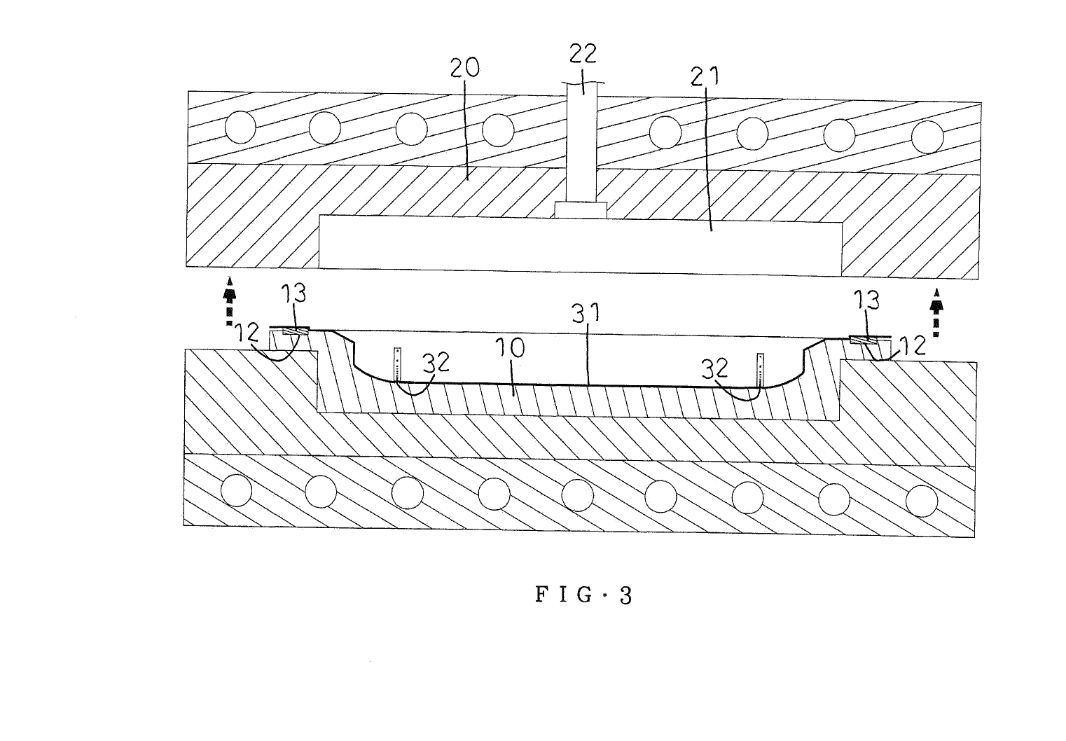

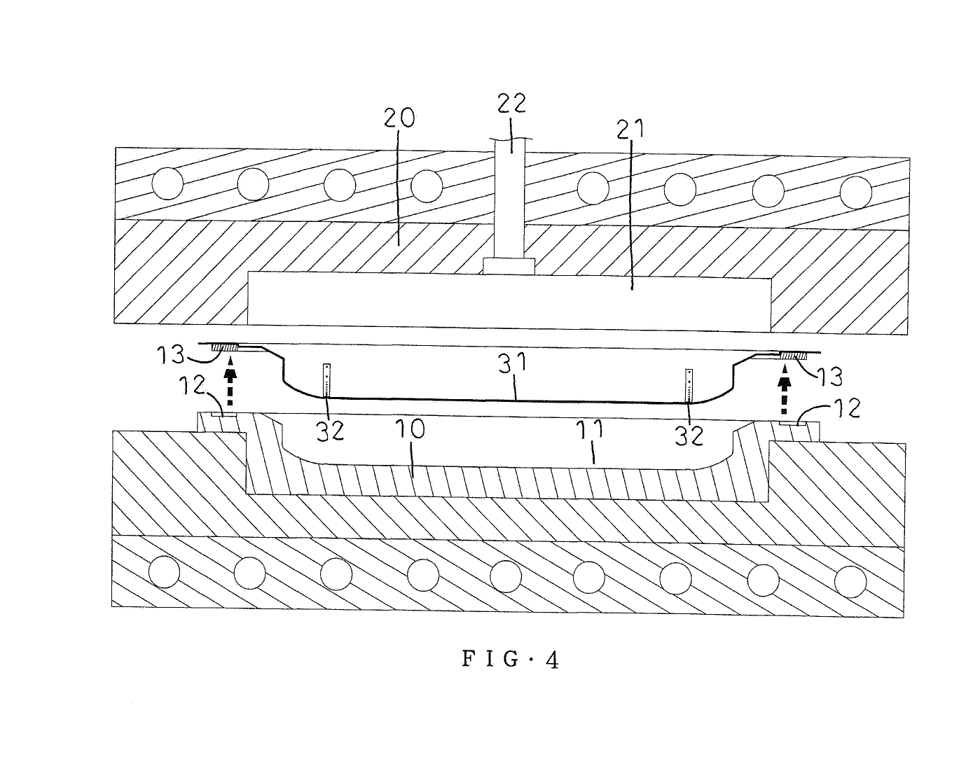

When the upper die 20 is moved downward to abut and close the lower die 10, the metallic plate 30 is subjected to a determined pressure. Then, the lower die 10 and the upper die 20 are heated by a heating device (not shown) to reach a proper temperature so as to deform the metallic plate 30. Then, the high pressure gas is delivered through the input pipe 22 into the upper die cavity 21 of the upper die 20 to blow and press the metallic plate 30 into the lower die cavity 11 of the lower die 10 as shown in FIG. 2 so as to form a metallic shell 31. Then, the upper die 20 is moved upward to open the lower die 10 as shown in FIG. 3. Then, the metallic shell 31 is removed from the lower die cavity 11 of the lower die 10 as shown in FIG. 4. At this time, the metallic plate 30 is separated from the lower die 10 by the separation washer 13 so that the metallic plate 30 will not be adhered to the lower die cavity 11 of the lower die 10 and is easily removed from the lower die cavity 11 of the lower die 10. Then, the metallic shell 31 is trimmed to remove the residual part so as to obtain an integrally formed product of the metallic shell 31. The metallic shell 31 has an outer surface provided with two slots 32 located at upper and lower portions of the metallic shell 31. The metallic shell 31 has an inner surface provided with two protruding arcuate faces 321 aligning with the slots 32 respectively. The metallic shell 31 is initially processed by an anodizing treatment. Then, the two arcuate faces 321 of the metallic shell 31 are processed by a CNC working procedure to have an insulating function. The inner surface of the metallic shell 31 is provided with a plurality of worked portions 322 which are processed by an etching process or a laser engraving working procedure. Then, the worked portions 322 of the metallic shell 31 are coated with a glue 323. Each of the slots 32 of the metallic shell 31 is provided with a plurality of through holes 33 equally spaced from each other.

Each of the slots 32 of the metallic shell 31 has two sides each provided with a small plane 34 for mounting an arcuate mold 35 which has a configuration the same as that of the metallic shell 31. The arcuate mold 35 has two sides slightly larger than the two sides of each of the slots 32. A spring “S” is placed at a rear portion of the arcuate mold 35 and abuts the arcuate mold 35.

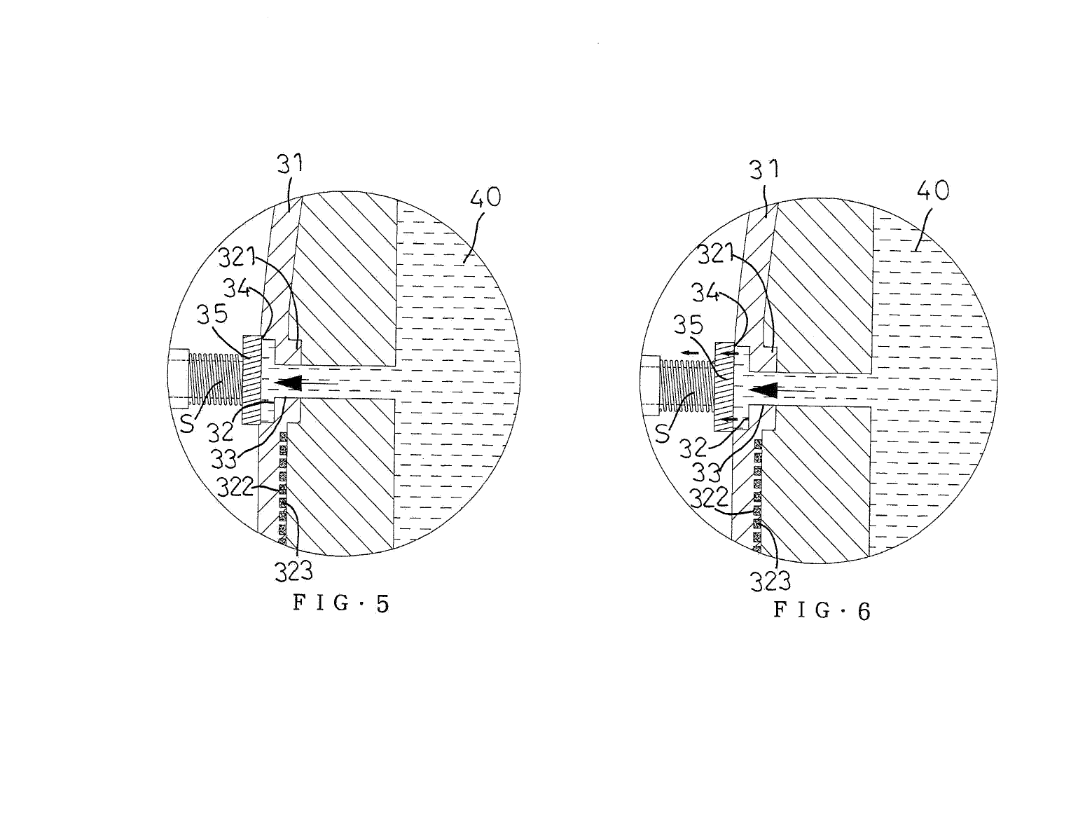

When an injection molding process is performed, the plastic material 40 is injected into the metallic shell 31, flows through the through holes 33 of the metallic shell 31, and flows into and out of the slots 32 of the metallic shell 31 as shown in FIG. 5. When the plastic material 40 touches and pushes the arcuate mold 35, the arcuate mold 35 is retained by the elasticity of the spring “S” to restrict movement of the plastic material 40, so that the overflow tolerance of the plastic material 40 is under an acceptable range as shown in FIG. 6. At this time, the cross-sectional zone between the metallic shell 31 and the plastic material 40 is a border after the plastic material 40 is formed. In such a manner, the plastic material 40 is embedded in the metallic shell 31 and extends through the metallic shell 31 from the inner surface of the metallic shell 31 to the outer surface of the metallic shell 31, so that the metallic shell 31 and the plastic material 40 are formed integrally after the injection molding process.

In the preferred embodiment of the present invention, the plastic material 40 is made of plastics. In addition, the metallic shell 31 is integrally formed by a thermoplastic molding process.

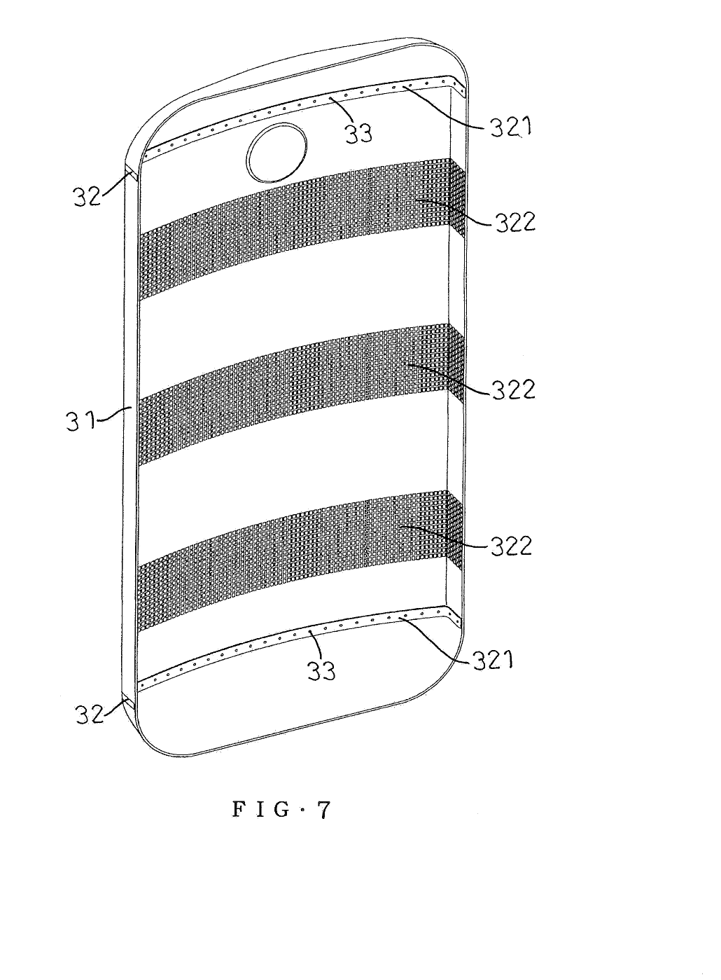

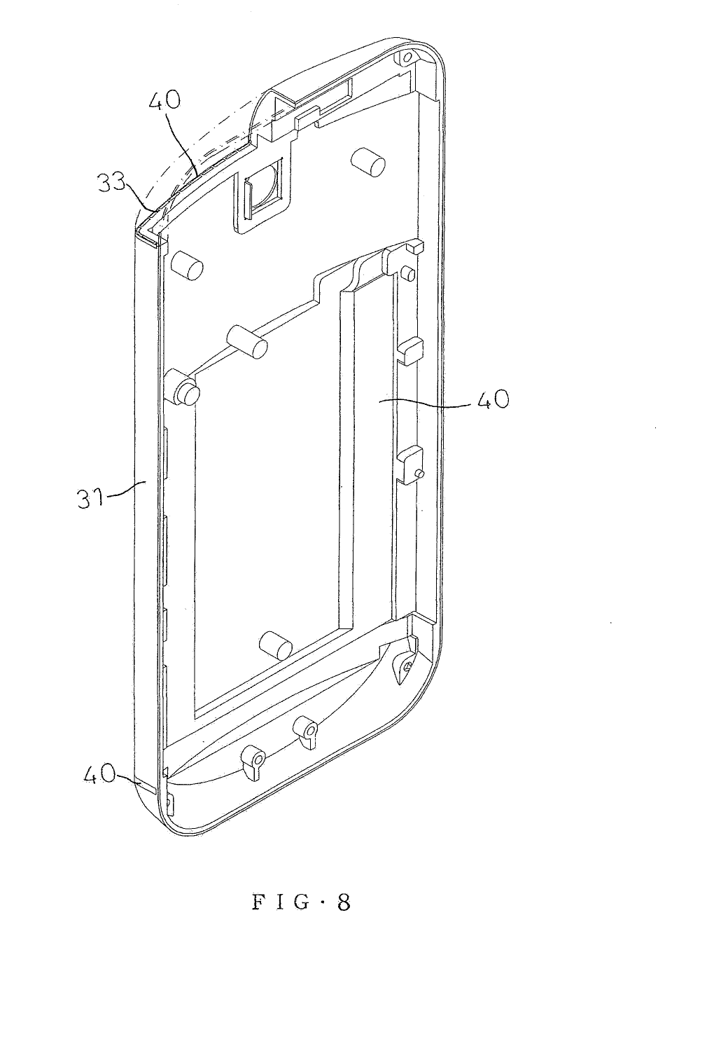

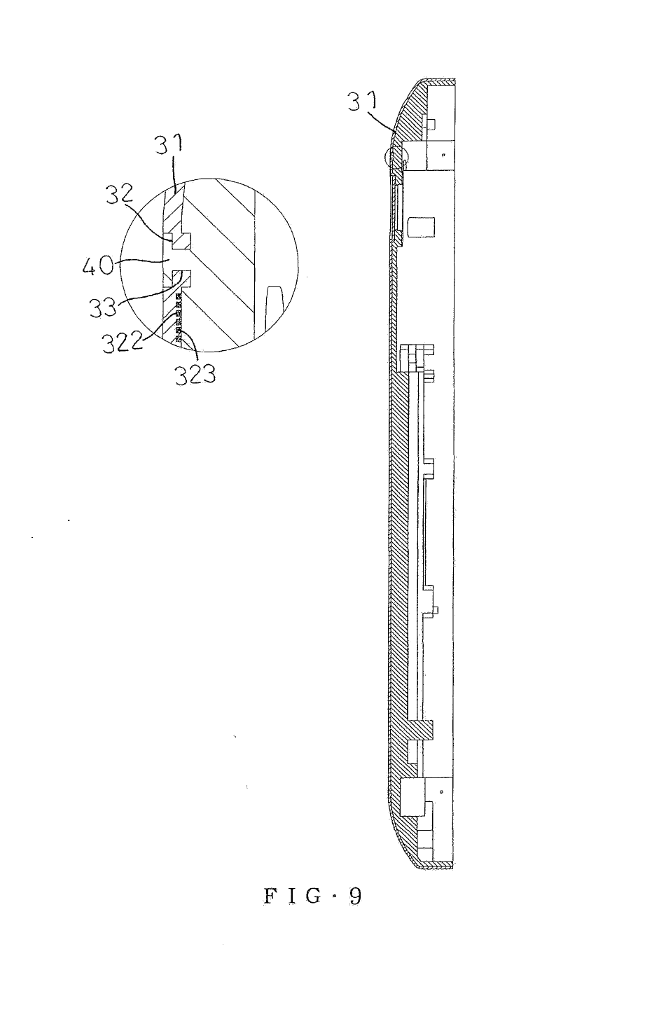

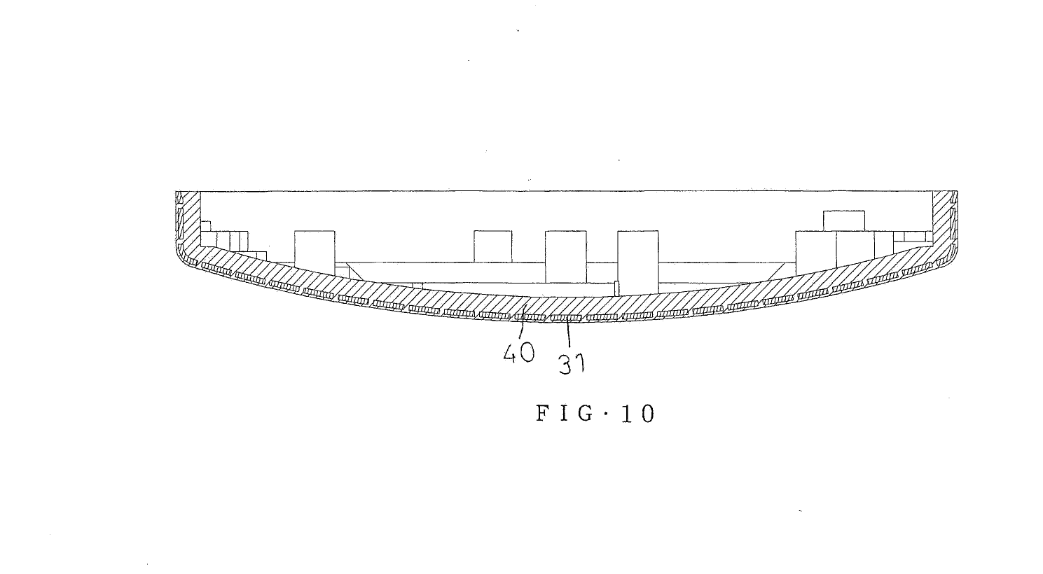

Referring to FIGS. 7-10 with reference to 1-6, a shell assembly in accordance with the preferred embodiment of the present invention comprises a metallic shell 31 and a plastic material 40 embedded into the metallic shell 31. The metallic shell 31 has an outer surface provided with at least one slot 32. The metallic shell 31 has an inner surface provided with at least one protruding arcuate face 321 aligning with the at least one slot 32. The metallic shell 31 is processed by an anodizing treatment. The at least one arcuate face 321 of the metallic shell 31 is processed by a CNC working procedure to have an insulating function. The inner surface of the metallic shell 31 is provided with at least one worked portion 322 which is processed by an etching process or a laser engraving working procedure. The at least one worked portion 322 of the metallic shell 31 is coated with a glue 323. The at least one slot 32 of the metallic shell 31 is provided with a plurality of through holes 33 equally spaced from each other. The plastic material 40 is injected into the metallic shell 31, flows through the through holes 33 of the metallic shell 31, and flows into and out of the at least one slot 32 of the metallic shell 31 during an injection molding process. The at least one slot 32 of the metallic shell 31 has two sides each provided with a small plane 34 for mounting an arcuate mold 35 which has a configuration the same as that of the metallic shell 31. A spring “S” is placed at a rear portion of the arcuate mold 35. When the plastic material 40 touches and pushes the arcuate mold 35, the arcuate mold 35 is retained by the elasticity of the spring “S” to restrict movement of the plastic material 40, so that the overflow tolerance of the plastic material 40 is under an acceptable range.

Accordingly, the plastic material 40 is injected into and embedded in the metallic shell 31, so that the metallic shell 31 and the plastic material 40 are formed integrally. In addition, the shell assembly is made easily and conveniently to reduce the cost of fabrication. Further, the shell assembly has an enhanced working precision to increase the quality of the product and to decrease the possibility of producing flawed products.

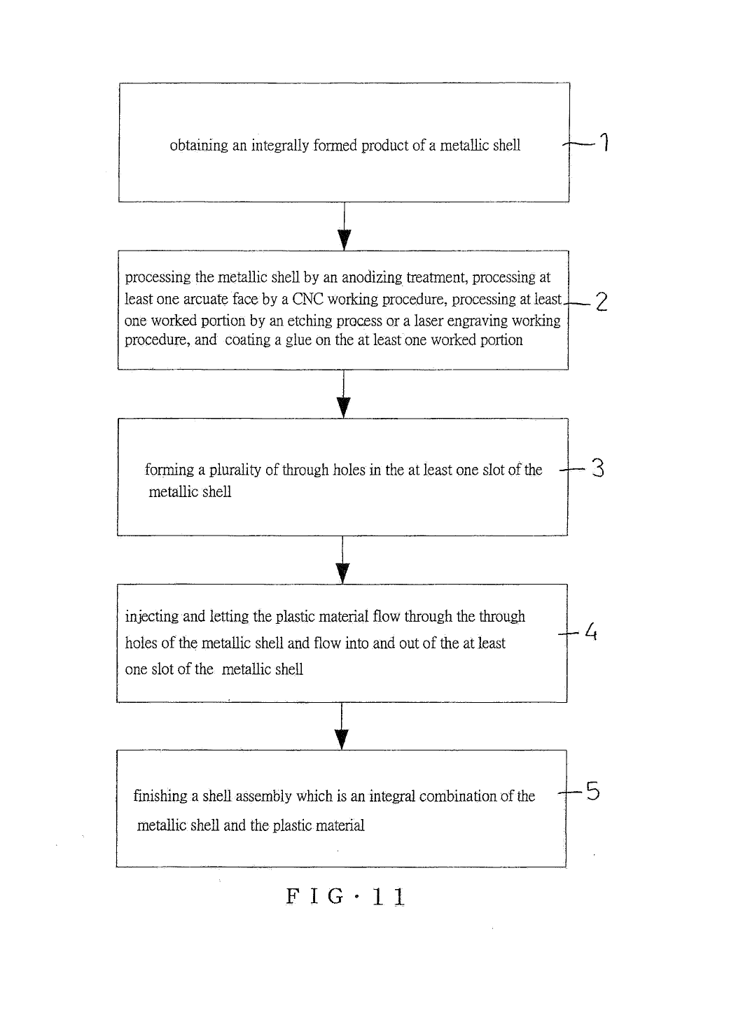

Referring to FIG. 11 with reference to 1-10, a method for manufacturing a shell assembly in accordance with the preferred embodiment of the present invention comprises a first step 1, a second step 2, a third step 3, a fourth step 4 and a fifth step 5.

The first step 1 includes placing a metallic plate 30 in a lower die 10 which has a periphery provided with an annular groove 12 for mounting a separation washer 13 which has a top higher than a top plane of the lower die 10, placing the metallic plate 30 on the top of the separation washer 13, moving an upper die 20 downward to apply a determined pressure on the metallic plate 30, heating the lower die 10 and the upper die 20 by a heating device to reach a proper temperature so as to deform the metallic plate 30, delivering a high pressure gas through the upper die 20 to blow and press the metallic plate 30 into a lower die cavity 11 of the lower die so as to form a metallic shell, moving the upper die upward to open the lower die, removing the metallic shell from the lower die cavity 11 of the lower die, and trimming the metallic shell to remove a residual part so as to obtain an integrally formed product of the metallic shell 31.

The second step 2 includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, and coating a glue on the at least one worked portion of the metallic shell.

The third step 3 includes forming a plurality of through holes in the at least one slot of the metallic shell.

The fourth step 4 includes injecting the plastic material 40 into the metallic shell 31 to let the plastic material 40 flow through the through holes 33 of the metallic shell 31 and flow into and out of the at least one slot 32 of the metallic shell 31 during an injection molding process.

The fifth step 5 includes finishing a shell assembly which is an integral combination of the metallic shell and the plastic material.

In the preferred embodiment of the present invention, the at least one slot 32 of the metallic shell 31 has two sides each provided with a small plane 34 for mounting an arcuate mold 35 which has a configuration the same as that of the metallic shell 31. The arcuate mold 35 has two sides slightly larger than the two sides of the at least one slot 32. A spring “S” is placed at a rear portion of the arcuate mold 35. When the plastic material 40 touches and pushes the arcuate mold 35, the arcuate mold 35 is retained by the elasticity of the spring “S” to restrict movement of the plastic material 40, so that the overflow tolerance of the plastic material 40 is under an acceptable range.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A shell assembly comprising:
a metallic shell; and
a plastic material embedded into the metallic shell;
wherein:
the metallic shell has an outer surface provided with at least one slot;
the metallic shell has an inner surface provided with at least one protruding arcuate face aligning with the at least one slot;
the metallic shell is processed by an anodizing treatment;
the at least one arcuate face of the metallic shell is processed by a CNC working procedure to have an insulating function;
the inner surface of the metallic shell is provided with at least one worked portion which is processed by an etching process or a laser engraving working procedure;
the at least one worked portion of the metallic shell is coated with a glue;
the at least one slot of the metallic shell is provided with a plurality of through holes; and
the plastic material is injected into the metallic shell, flows through the through holes of the metallic shell, and flows into and out of the at least one slot of the metallic shell during an injection molding process.

2. The shell assembly of claim 1, wherein the metallic shell is integrally formed by a thermoplastic molding process.

3. The shell assembly of claim 1, wherein the plastic material is made of plastics.

4. The shell assembly of claim 1, wherein:
the at least one slot of the metallic shell has two sides each provided with a small plane for mounting an arcuate mold which has a configuration the same as that of the metallic shell;
a spring is placed at a rear portion of the arcuate mold; and
when the plastic material touches and pushes the arcuate mold, the arcuate mold is retained by an elasticity of the spring to restrict movement of the plastic material, so that an overflow tolerance of the plastic material is under an acceptable range.

5. A method for manufacturing a shell assembly, comprising:
a first step, a second step, a third step, a fourth step and a fifth step;
wherein:
the first step includes placing a metallic plate in a lower die which has a periphery provided with an annular groove for mounting a separation washer which has a top higher than a top plane of the lower die, placing the metallic plate on the top of the separation washer, moving an upper die downward to apply a determined pressure on the metallic plate, heating the lower die and the upper die by a heating device to reach a proper temperature so as to deform the metallic plate, delivering a high pressure gas through the upper die to blow and press the metallic plate into a lower die cavity of the lower die so as to form a metallic shell, moving the upper die upward to open the lower die, removing the metallic shell from the lower die cavity of the lower die, and trimming the metallic shell to remove a residual part so as to obtain an integrally formed product of the metallic shell;
the second step includes forming at least one slot in the metallic shell, processing the metallic shell by an anodizing treatment, processing at least one arcuate face of an inner surface of the metallic shell by a CNC working procedure to have an insulating function, processing at least one worked portion of the inner surface of the metallic shell by an etching process or a laser engraving working procedure, and coating a glue on the at least one worked portion of the metallic shell;
the third step includes forming a plurality of through holes in the at least one slot of the metallic shell;
the fourth step includes injecting the plastic material into the metallic shell to let the plastic material flow through the through holes of the metallic shell and flow into and out of the at least one slot of the metallic shell during an injection molding process; and
the fifth step includes finishing a shell assembly which is an integral combination of the metallic shell and the plastic material.

6. The method of claim 5, wherein the metallic shell is integrally formed by a thermoplastic molding process.

7. The method of claim 5, wherein the plastic material is made of plastics.

8. The method of claim 5, wherein the at least one slot of the metallic shell has two sides each provided with a small plane for mounting an arcuate mold which has a configuration the same as that of the metallic shell, the arcuate mold has two sides slightly larger than the two sides of the at least one slot, a spring is placed at a rear portion of the arcuate mold, and when the plastic material touches and pushes the arcuate mold, the arcuate mold is retained by an elasticity of the spring to restrict movement of the plastic material, so that an overflow tolerance of the plastic material is under an acceptable range.
